(19) United States
(12) Patent Application Publication
(10) Pub. No.: US 2013/0088063 A1
(43) Pub. Date: Apr. 11, 2013

(54) Child Neck Support Apparatus for Seats

(71) Applicant: Emmanuel Montes, Madera, CA (US)

(72) Inventor: Emmanuel Montes, Madera, CA (US)

(21) Appl. No.: 13/269,956

(22) Filed: Oct. 10, 2011

(51) Int. Cl. A47D 1/00; B60N 2/26; A47C 7/54; B60N 2/48

(52) U.S. Cl. 297/393; 297/391; 297/397

(57) ABSTRACT

A neck support apparatus for use with car seats and the like to prevent a child's head from swinging side to side and forward when the child is asleep in the seat. The apparatus comprises a base and a support pillow removably attached to the base. The base has a seat section and a back support riser that is attached to or integral with the seat section. The support pillow has a pillow body with a pair of neck support members extending outwardly from the front side of the pillow body to partially enclose the child's neck and support the child's head in the apparatus. Slots in the back support riser receive straps attached to the pillow body. A head engaging device can help hold the child's head in an upright position. The support pillow can have a character shape, such as a bear or the like.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to apparatuses utilized with a child car seat, booster seat, stroller or other type of seat to more safely and comfortably secure the child in the seat. More particularly, the present invention relates to such apparatuses that are configured to support the child's neck so as to reduce or substantially eliminate undesirable movement of the child's head while he or she is sitting in the seat. Even more particularly, the present invention relates to such apparatuses that can be attached to or incorporated into a variety of different seats.

B. Background

The use of child car seats to safely secure toddlers and small children in a moving vehicle is well known in the prior art. In fact, most states mandate that children under a certain weight and/or height must be secured in a specially configured car seat. Approved car seats are designed to restrain the child in the event the vehicle in which he or she is riding rapidly decelerates, suddenly stops or is involved in an accident or other impact event that would otherwise cause an unsecured child to impact the inside of the vehicle and be injured or killed. The typical car seat includes a body portion that is secured to a seat in the vehicle and a harness system that secures the child to the car seat. The body portion has back, bottom and side walls that are dimensioned to receive the child in an upright, outwardly facing position. Harness systems typically comprise a plurality of straps that define a shoulder portion which is placed over the child's shoulders and secured together near his or her chest and a waist or lower body portion that engages the child's pelvis area, often between the child's legs, and is joined to the shoulder portion. The car seat harness system locks to securely hold the child in the car seat and prevent the child from being ejected from the car seat. Many car seats also comprise a safety bar that is pivotally attached to the body portion so it can be pivoted upward to place a child in or remove a child from the car seat and pivoted downward and locked into position to help secure the child in the car seat.

Although child car seats perform well with regard to restraining a child in a vehicle, it is generally well known that conventional car seats do not provide much, if any, support for the child's head or neck. It is also well known that children tend to fall asleep in car seats when the vehicle is moving. When this happens, the child's head will typically sag, droop or otherwise hang forward or lay to his or her side. Prolonged hanging of the head is known to be relatively uncomfortable and can result in a sore neck. The lack of support for the child's head can also cause the child to wake prematurely and frequently, typically resulting in an unhappy child that someone in the vehicle, which is often only the driver of the vehicle, must either ignore or address the problem, usually by stopping the vehicle. A child falling asleep or between being awake and asleep will tend to swing his or her head between the forward and side to side positions, causing even more discomfort and neck soreness. As the vehicle moves along the road, particularly around corners, the swinging of the child's head is further exasperated, usually significantly increasing the problems associated with a lack of head/neck support in child car seats. Typically, someone in the vehicle will adjust the child's position in an attempt to lessen the swinging, often by laying the child's head against one of the sides of the car seat or by placing a towel or other soft support alongside the child's head. Naturally, if the only other person in the vehicle is the driver, then he or she must stop the vehicle make the necessary adjustments to the child's position.

Although typically to a lesser extent, the same problem with regard to the lack of head and neck support also exists in other types of seats where a child is likely to sit. For instance, most strollers, highchairs and other seats that are either specially configured for children or are commonly utilized by children do not have an apparatus to help secure the child so as to avoid injury or soreness to the child's neck. As with child car seats, children commonly fall asleep in these non-car seats and the child's head will sag, droop or otherwise hang forward or lay to his or her side. Movement of the seat with the child sitting in the seat, such as is common for a stroller and other moveable seats, tends to cause the child's head to move back and forth, sometimes rather significantly, and can easily result in the child having a very sore neck.

A variety of prior art apparatuses have been proposed in an attempt to solve the problems associated with a lack of head/neck support in child car seats and other types of seats. These prior art head/neck support apparatuses have drawbacks that have generally limited their acceptance, including undesired restriction of the child's shoulders, arms and/or head, restriction of vision, lack of adjustability, incompatibility with some of the available child seats and difficultly with cleaning. Although some of the available apparatuses can support a child's neck, they are not configured to be securely held in place in the seat, thereby resulting in the apparatus moving to a position, including out of the seat, where the apparatus is unable to provide the desired support. In addition, many of the prior art apparatuses provide little or no frontal head support, thereby not solving the problems associated with the child's head hanging forward. Some of the prior art apparatuses are primarily configured for infants and, as such, are generally incompatible with toddlers. Other prior art apparatuses have a portion that fully encircles the neck, which could be uncomfortable and may be dangerous for the child, particularly in a rapid deceleration event.

As stated above, the prior art devices either do not sufficiently solve the problem of the child's head swinging in the car seat or do so in a manner that has not been widely accepted. What is needed, therefore, is an improved neck support apparatus for child car seats and other seats that safely and effectively supports a child's head and neck while he or she is in the seat so as to reduce or substantially eliminate the swinging head movement and the uncomfortableness and soreness that typically results. The preferred neck support apparatus should be easily adapted for use with a variety of different types of seats, including car seats, strollers, highchairs and the like, and for children of different sizes. In addition, the preferred apparatus should be easy to install and easy to remove from the seat. The apparatus should be suitable for customization by the manufacturer so as to make the support apparatus more appealing to children. The preferred apparatus should be easy to clean and relatively inexpensive to manufacture.

### SUMMARY OF THE INVENTION

The child neck support apparatus for seats of the present invention solves the problems and provides the benefits identified above. That is to say, the present invention discloses a neck support apparatus that is utilized with a child car seat, stroller, highchair or other child seat to effectively support a child's head and neck while he or she is sitting in the seat in a manner that reduces or substantially eliminates swinging movement of the child's head. As such, the neck support apparatus of the present invention is more comfortable for the child and substantially reduces the soreness that typically results from a child falling asleep in the seat. In a preferred configuration, the neck support apparatus is configured for use with a variety of different types of seats, including car seats, strollers, highchairs and the like, and for use with children of different sizes. The preferred configuration of the present neck support apparatus can be easily and quickly installed on and removed from a child's seat, allowing the user to move the apparatus from one seat to another and to remove/reinstall the apparatus for cleaning. In a preferred configuration, the neck support apparatus is simple to adjust for the size and comfort of the child. If desired, the neck support seat of the present invention can be made into a variety of different configurations and/or shapes, such as animal or cartoon characters. In the preferred embodiment, the neck support apparatus is inexpensive to manufacture.

In a primary embodiment of the present invention, the neck support apparatus for use with a child's seat generally comprises a base and a support pillow attached to the base. The base has a seat section and a back support riser, with the back support riser attached to or integral with the seat section and extending generally upwardly therefrom. In use, the child sits on the seat section and rests his or her back against the back support riser. The seat section of the base is sized and configured to be at least substantially received in a seating area of or integrated into the car seat, stroller, highchair or other seat. The back support riser is sized and configured to be at least substantially received against the back wall of the seat. The support pillow has a pillow body with a front side and a back side. In use, the back side of the pillow body is attached in abutting relation to the back support riser of the base. The support pillow also has one or more neck support members that extend generally outwardly from the front side of the pillow body so as to at least partially enclose the neck of the child when the child is sitting on the neck support apparatus in the seat. In one embodiment, the apparatus also has an attachment means that interconnects the support pillow and the base to allow the user to removably attach the support pillow to the base. In one configuration, the attachment means comprises one or more slots in the back support riser of the base and one or more strap members attached to or otherwise associated with the pillow body, with each of the strap members being sized and configured to be received through at least one of the one or more slots. Each strap member has a connecting means for connecting the strap member to itself to secure the support pillow to the base. In one configuration each of the strap members extend to the back side of the back support riser in a manner that attaches the support pillow to a front side of the back support riser. The apparatus can include an arm rest on each of a first side and a second side thereof. In one configuration, the support pillow has a pair of the neck support members. The neck support apparatus of the present invention can include a head support mechanism that interconnects the head of the child and the neck support apparatus for supporting the head in a generally upright position. In one configuration, the head support mechanism can comprise a head engaging device that is configured to engage the child's head and a securing means that interconnects the head engaging device and the support pillow so as to secure the head engaging device to the support pillow. The head engaging device can be a cap, such as a baseball type of cap, beanie, sweat band, sun visor or a variety of other similar devices that is configured to be received on or over the child's head and attached to the support pillow. The support pillow can be configured in a character shape, such as an animal, person or other object, with one or more of the neck support members being integral with the character shape, such as being the arms of a bear.

Accordingly, one of the primary aspects of the present invention is to provide a neck support apparatus for child car seats that has the advantages discussed above and overcomes the disadvantages and limitations associated with presently available seat neck and head support apparatuses.

It is an important aspect of the present invention to provide a neck support apparatus that is configured for use with a child car seat, highchair, stroller or the like to reduce or substantially eliminate the problems associated with a child's head swinging freely in the seat when he or she is asleep.

It is also an important aspect of the present invention to provide a neck support apparatus for car seats that is also adaptable for use with a variety of different types of child seats, including strollers and highchairs, and for different sizes of children.

It is also an important aspect of the present invention to provide a neck support apparatus for child car seats that is easy to install on and remove from a conventional car seat and other types of seats, thereby allowing the user to easily and quickly move the apparatus from one seat to another and/or remove and reinstall the apparatus for cleaning.

Another important aspect of the present invention is to provide a neck support apparatus for child car seats that can be customized by forming the apparatus into various animal, cartoon, people and other shapes.

Yet another important aspect of the present invention is to provide a neck support apparatus for seats used by children, including car seats, strollers, highchairs and the like, that is relatively inexpensive to manufacture.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a front view of a conventional prior art car seat;

FIG. 2 is a front view of a neck support apparatus that is configured according to a first embodiment of the present invention shown in use with a child sitting in the car seat of FIG. 1;

FIG. 3 is a front view of the neck support apparatus of FIG. 2 shown separate from the seat;

FIG. 4 is a top view of the neck support apparatus of FIG. 3;

FIG. 5 is a front view of the base of the neck support apparatus of FIG. 3 shown with the detachable pillow removed therefrom;

FIG. 6 is a side view of the base of FIG. 5;

FIG. 7 is a front view of the pillow of the neck support apparatus of FIG. 3 shown removed from the base thereof;

FIG. 8 is a top view of the pillow of FIG. 7;

FIG. 9 is a front view of a neck support apparatus that is configured according to a second embodiment of the present invention shown in use with a child sitting in the car seat of FIG. 1 and a hat being utilized as a head device;

FIG. 10 is a back view of the head device of FIG. 9 showing the use of a hook-and-loop material as the attachment mechanism;

FIG. 11 is a front view of an alternative configuration for the pillow of the neck support apparatus, shown removed from the base thereof, and a back view of a hat as the head device and the use of straps as the attachment mechanism; and

FIG. 12 is a front view of an alternative configuration for the pillow of the neck support apparatus shown configured as a bear as the character shape.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain configurations for the components of the neck support apparatus, those skilled in the art will readily understand that this is merely for purposes of simplifying the present disclosure and that the present invention is not so limited.

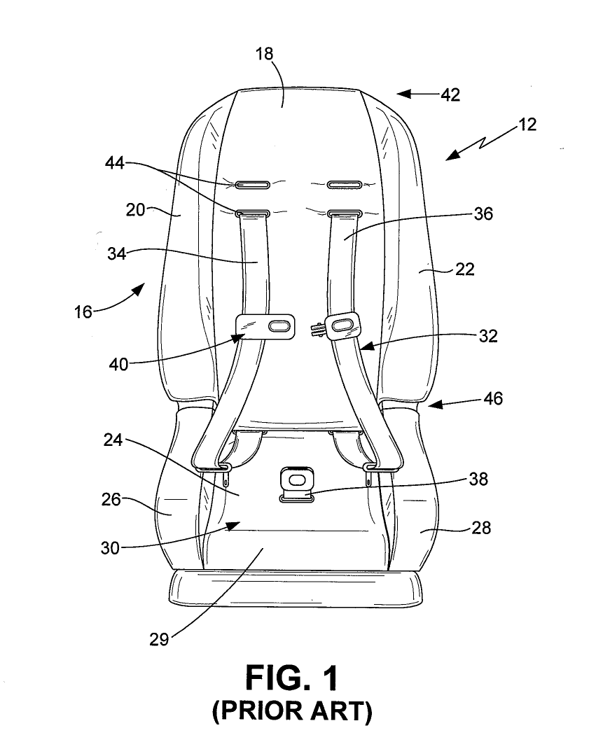

A neck support apparatus that is configured pursuant to one of the preferred embodiments of the present invention is identified generally as 10 in FIGS. 1 through 4. The neck support apparatus 10 is configured for use with a seat 12, such as the conventional child car seat shown in FIGS. 1, 2 and 9, that is utilized by a child 14 to more comfortably and safely sit in the seat 12. The neck support apparatus 10 of the present invention can be utilized with a variety of different types of seats 12. The car seat shown in FIGS. 1, 2 and 9 is utilized herein to describe the features of the apparatus 10 of the present invention and is not intended to limit the use of the present apparatus 10 in any manner. As is commonly known, a child car seat is used to safely secure a child 14 in a moving vehicle. A conventional car seat 12 has a body portion 16 comprising a back wall 18 that interconnects a pair of spaced apart upper side walls 20/22 and a lower wall 24 which interconnects a pair of spaced apart lower side walls 26/28 that, with front edge 29, define the seating area 30 where the child 14 sits. Car seat 12 also has a securing assembly 32 comprising a pair of shoulder straps 34 and 36, a lap strap 38 and a locking mechanism 40 that lockingly joins the shoulder 34/36 and lap 38 straps to secure the child 14 to the car seat 12. The body portion 16 of seat 12 is made out of a hard plastic or other relatively lightweight and strong material, which is usually covered with a soft cloth or cloth-like material for the comfort of the child 14 sitting in car seat 12, and the shoulder 34/36 and lap 38 straps are made out of a generally inelastic material selected to protect the child 14 in case of sudden acceleration or deceleration or an accident. In use, the car seat 12 is secured inside the vehicle, typically to one of the passenger seats in the vehicle. The upper end 42 of back wall 18 has one or more pairs of slots 44, usually a plurality, that the shoulder straps 34/36 pass through. The user of car seat 12 selects the pair of slots 44 to utilize based on the size of the child 14, with a larger child typically requiring use of the slots 44 disposed closer to the upper end 42 of back wall 18 as opposed to those disposed towards lower end 46 of back wall 18. As noted above, the car seat 12 does not include any support system or apparatus for the child's neck 47 or head 48 or any way of preventing the child's head 48 from swinging forward (away from the back wall 18) or from side to side inside the seating area 30 of car seat 12 when the child 14 is asleep or otherwise unable to hold his or her head 48 in an upright position. It is generally commonly known that this swinging motion is uncomfortable and can possibly cause soreness or injury to the child 14.

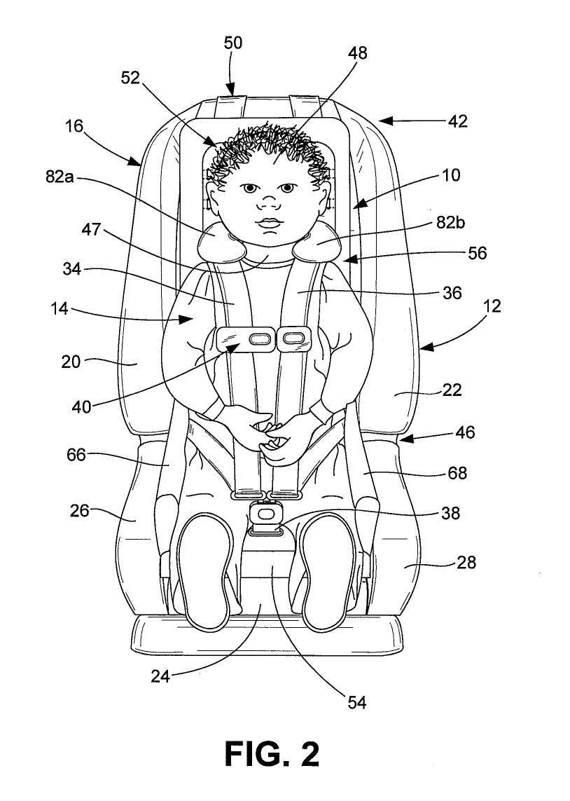

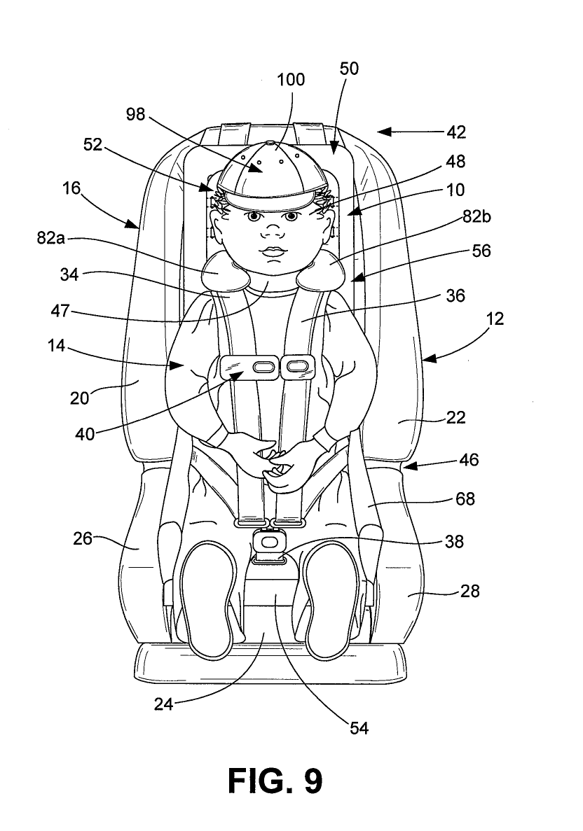

The neck support apparatus 10 of the present invention is configured to be utilized with the car seat 12 shown in FIG. 1, as well as with highchairs, strollers and other seats 12 having a seating area 30 in which a child 14 sits, to support the child's neck 47 and head 48 in a manner that generally prevents the head 48 from swinging around in the seat 12. With the child's neck 47 and head 48 supported, the apparatus 10 reduces or substantially eliminates discomfort and soreness for the child 14. In a first configuration, shown in FIGS. 2, 3 and 4, the neck support apparatus 10 generally comprises a base 50 which is sized and configured to be received in the seating area 30 of seat 12 and a support pillow 52 that is removably attached to base 50. The child 14 sits on the base 50 while it is inside the seating area 30 and the support pillow 52 supports the child's neck 47 and head 48 in a manner that prevents the undesirable swinging motion that can occur when the child 14 is asleep or otherwise unable to support his or her head 48 in a generally upright manner. Even for child 14 who is awake, pillow 52 provides support for the neck 47 and head 48 to allow him or her to comfortably and safely sit in the seat 12, particularly if seat 12 is a car seat that is located in a moving vehicle. In one embodiment, base 50 can be manufactured out of plastic or other relatively stiff material having one or more cushions thereon that are covered with cloth or other soft material against which the child 14 will be placed. The stiff plastic or other material will provide the desired support for the base 50. The support pillow 52 can be made out of a soft cushion or pillow-like material that is comfortable for child 14 to place his or her neck 47 and head 48 against, as shown in FIGS. 1 and 9. Preferably, at least the outer portions of the material for the base 50 and pillow 52 are configured to be washable. As may be required or desirable, the outer portion of each of these components can be configured to be removed so the user can wash them in a conventional washing machine and dry them in a conventional dryer.

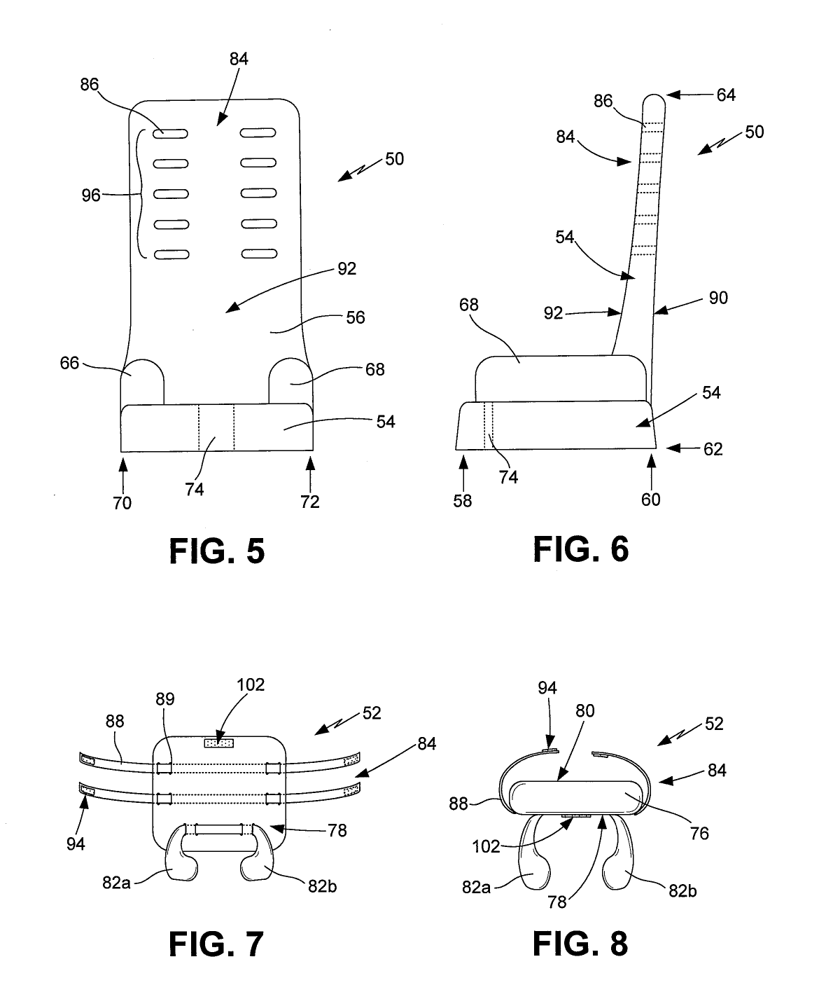

As best shown in FIGS. 5 and 6, the base 50 generally comprises a seat section 54 which is placed on lower wall 24 of the seat 12 and on which the child 14 sits and an upright back support riser 56 that extends upwardly from the seat section 54 and is placed against the back wall 18 of the seat 12 and against which the child 14 leans. The seat section 54 of base 50 has a first or front end 58 and a second or back end 60 and the back support riser 56 has a first or lower end 62 and a second or upper end 64, as shown in FIG. 6. The lower end 62 of the back support riser 56 is attached to or integrally formed with the back end 60 of the seat section 54. In one configuration of neck support apparatus 10, the base 50 can comprise a pair of arm rests, shown as first arm rest 66 and second arm rest 68, on the first side 70 and second side 72, as best shown in FIG. 5. Preferably, the seat section 54 of base 50 should be sized and configured to at least substantially fit within area of the lower wall 24 of the seat section 30 of seat 12, such as between the lower side walls 26/28 and between the back wall 18 and the front edge 29 of seat 12. Likewise, it is preferred that the back support riser 56 be sized and configured to at least substantially fit within the area of the back wall 18, such as between the upper side walls 20/22 and between the upper end 42 and the lower end 46 of the back wall 18. For use with a car seat as seat 12, the seat section 54 should have belt opening 74 sized and configured to receive the lap strap 38 therethrough so the child 14 can be secured inside the car seat 12 while using apparatus 10.

As best shown in FIGS. 7 and 8, the support pillow 52 comprises a pillow body 76, which has a forwardly facing front side 78 and a rearwardly facing back side 80, that is shaped and configured to receive and support the back of the child's head 48 (against the front side 78) when he or she is sitting on the neck support apparatus 10 in seat 12, as shown in the examples of FIGS. 2 and 9, and one or more neck support members, shown as first neck support member 82a and second neck support member 82b (collectively, they are referred to as neck support members 82) that are sized and configured to extend outward from the front side 78 and at least partially around the neck 47 of the child 14. In a preferred embodiment, the support pillow 52 has a pair of support members 82 that extend outwardly from the front side 78 of the pillow body 76 and turn at least partially inward to support the sides of the child's neck 47. The pillow body 76 should be configured to be relatively soft, somewhat like a firm bed pillow or couch pillow, to maintain the child's head 48 in spaced apart relation to the back support riser 56. The support members 82 should be sufficiently stiff to extend outward from the back support riser 56 and provide the desired left/right support necessary to substantially prevent the child's head 48 from swinging back and forth. For the child's comfort, the pillow body 76 and support members 82 should be covered with a soft, cushy material.

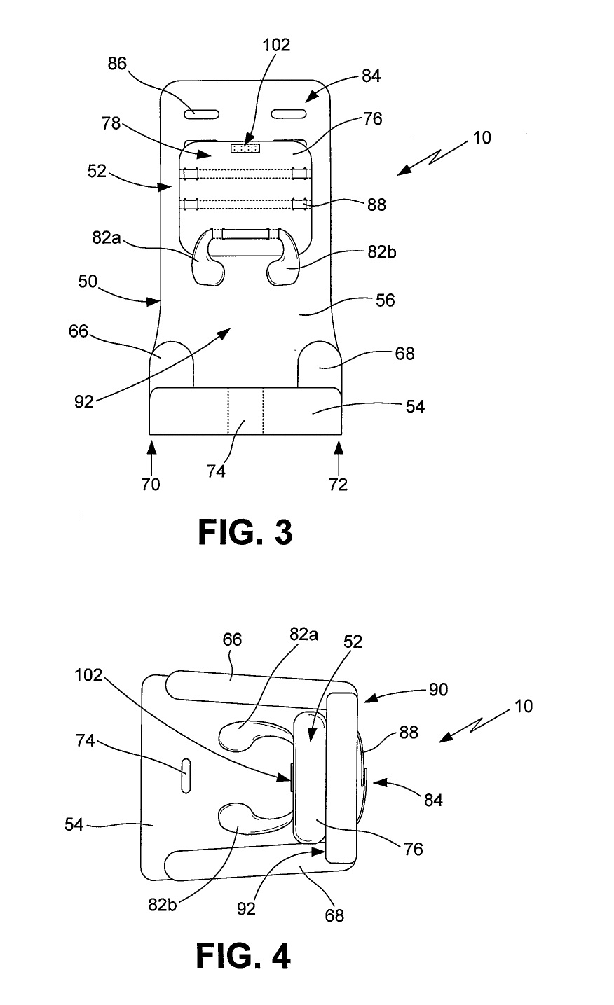

As best shown in FIGS. 3 and 4, the support pillow 52 attaches to the base 50 to form the neck support apparatus 10 of the present invention. In one embodiment, the support pillow 52 can be fixedly attached to the base 50. In the preferred embodiment, however, support pillow 52 removably attaches to the base 50 utilizing an attachment means 84 so the user can clean the components of apparatus 10 separately and to allow him or her to selectively position the support pillow 52 on the base 50 to best fit the child 14 who will be utilizing the apparatus 10. In the embodiment shown, the attachment means 84 comprises one or more, preferably a plurality, of slots 86 in the back support riser 56 that are each sized and configured to receive one or more strap members 88 attached to pillow body 76. In the embodiment shown in FIGS. 3 through 8, the back support riser 56 has six pairs of slots 86 positioned between the lower end 62 and upper end 64 thereof to allow the user to have multiple positions to place the support pillow 52. These figures also show the use of two elongated strap members 88 that extend through and around the pillow body 76 to be received through the slots 86 and around the back side 90 of the back support riser 56 so as to hold the support pillow 52 tightly against the front side 92 of the back support riser 56. In this embodiment, the two elongated strap members 88 extend across the back side 80 of the pillow body 76, pass through the pillow body 76, wrap around the edges of the front side 78 of the pillow body and then pass through the slots 86 in the back support riser 56. The two ends of each strap member 88 connect on the back side 90 of the back support riser 56 using a connecting means 94. In the embodiment shown, the connecting means 94 comprises hook-and-loop material, such as VELCRO® or the like. As will be readily appreciated by those skilled in the art, a variety of different connectors can be utilized for the connecting means 94, including snaps, buttons, ties, buckles, locking buckles (such as used on packs and the like), strong magnets and the like. Connecting means 94 needs to be selected so as to be sufficiently strong enough to hold the support pillow 52 in place on the back support riser 56 of base 50 when the apparatus 10 is in use by child 14. Although the two strap members 88 are shown as elongated members that abut the back side 80 of the pillow body 76 and pass through pillow body 76 to secure the support pillow 52 to the base 50, those skilled in the art will readily appreciate that the strap members 88 can be configured with one end that is fixedly attached to the pillow body 76 and that one or more strap members 88 can be utilized with apparatus 10.

As set forth above, in a preferred embodiment the attachment means 84 used to removably attach support pillow 52 from the back support riser 56 of the base 50, comprises slots 86 in the riser 56 and strap members 88 associated with the support pillow 52 that are received through the slots 86. In an alternative embodiment, the attachment means 84 can comprise a wide variety of different types of devices that can removably attach the support pillow 52 from base 50. For instance, appropriately configured hook-and-loop material, snaps, ties, strong magnets, clips, wires and the like can be used to achieve the desired removable attachment for support pillow 52. Any such attachment means 84 should be selected so as to securely, but removably, attach the support pillow 52 to the back support riser 56 of the base 50 of apparatus 10.

In the preferred embodiment, such as the embodiments shown in FIGS. 1 through 8, the attachment means 84 is configured to allow the user to place the support pillow 52 on the back support riser 56 in a position that is the most beneficial and comfortable for the child 14. In the embodiment shown, the back support riser 56 has a pair of slots 86 extending in a plurality of slot rows, shown as 96 on FIG. 5, with each pair of slots 86 comprising one position for the support pillow 52. In this manner, support pillow 52 can be positioned between the lower end 62 and the upper end 64 of the back support riser 56 such that the neck supports 82 will be beneficially placed around the neck 47 of the child 14, as shown in FIG. 2, to prevent undesirable movement of the child's head 48 while he or she is asleep, particularly when seat 12 is a car seat in a moving vehicle.

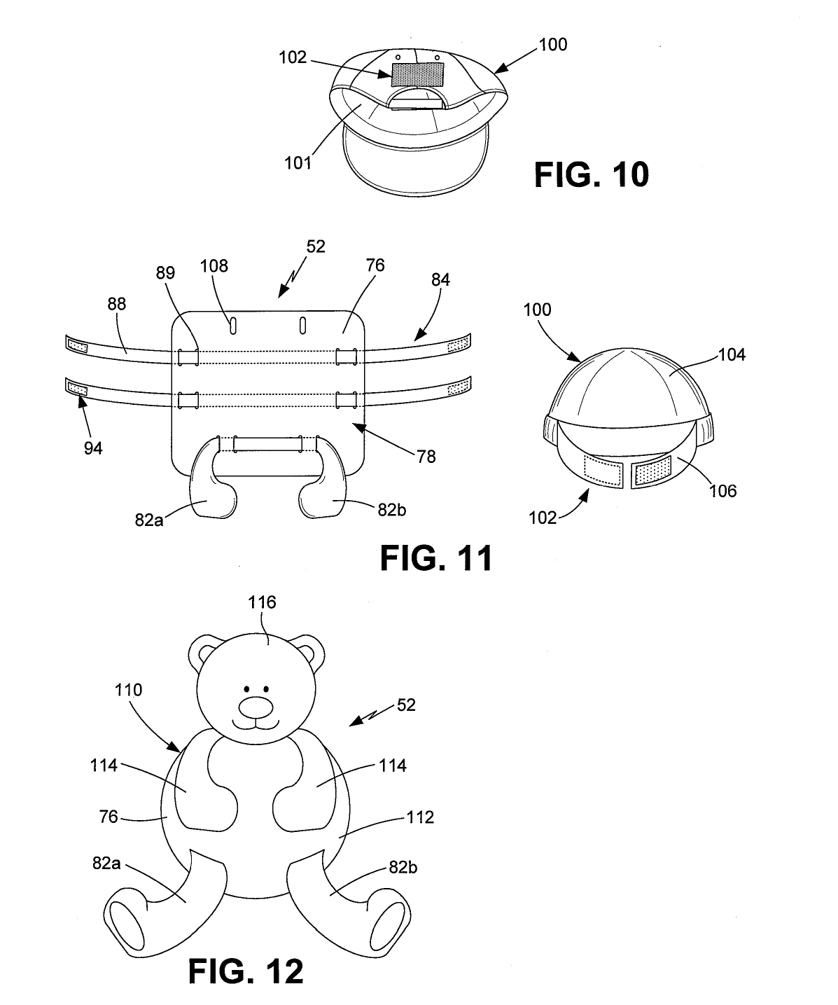

Although the neck support apparatus 10 can be configured as set forth above and shown in FIGS. 2 through 8, in a preferred configuration the neck support apparatus 10 also comprises a head support mechanism 98 that is configured to help hold the child's head 48 in a generally upright position while his or her neck 47 is supported by the neck support members 82. The head support mechanism 98 should be configured to engage and support the child's head 48, as opposed to the child's neck 47, and substantially hold the child's head 48 in an upright position, as shown in FIG. 9. In one configuration of this embodiment, the head support mechanism 98 comprises a head engaging device 100, such as the baseball cap 101 shown in the embodiment of FIGS. 9 and 10. Head engaging device 100 is secured to the pillow body 76 of the support pillow 52. Although the head engaging device 100 can be fixedly secured to the pillow body 76 or other area of support pillow 52, in a preferred configuration the head engaging device 100 is removably secured to the pillow body 76 with securing means 102, best shown in FIGS. 3-4, 7-8 and 10-11. In the embodiment of FIGS. 3-4, 7-8 and 10, the securing means 102 comprises one or more strips of hook-and-loop material. Alternatively, securing means 102 can be snaps, ties, buttons, magnets, clips and the like (as described above for attachment means 84 and/or connecting means 94). The embodiment of FIG. 11 shows the head engaging device 100 as a beanie 104 or the like and the securing means 102 as comprising one or more strap members 106 that are received through slots 108 in the pillow body 76 in a manner that securely attaches the beanie 104 to the support pillow 52. As will be readily appreciated by those skilled in the art, a variety of different types of hat or hat-like devices, including headbands and visors, can be utilized as the head engaging devices 100. The head engaging device 100 should be selected so as to hold onto the child's head 48 and, while being worn by child 14 and secured to the pillow body 76 of the support pillow 52, substantially prevent undesirable front to back movement of the child's head 48, particularly when seat 12 is a car seat that is in a moving vehicle.

If desired, the support pillow 52 can comprise a character shape 110 to make the neck support apparatus 10 of the present invention more appealing, and therefore more likely to be willingly utilized, to the child 14. The embodiment of FIG. 12 shows one possible type of character shape 110 that can be utilized for support pillow 52. In this embodiment, the character shape 110 is a bear 112 that is configured with its legs as the neck support members 82, such that the legs (support members 82) will go at least partially around the child's neck 47 to help support his or her head 48 while using apparatus 10. In this embodiment, the arms 114 and head 116 of the bear 112 are left to either hang over the child's shoulders or be formed in a cap or cap-like structure that is placed over the head 48 of the child 14 and, if desired, essentially function as a head engaging device 100. As will be readily appreciated by those skilled in the art, a wide variety of different character shapes 110 can be utilized with the apparatus 10 of the present invention. For instance, character shape 110 can be a variety of different animals, cartoon characters, people (including specific people or general people characters (like a clown or the like)) and/or other shapes that are likely to be appealing to the child 14 using the apparatus 10.

In use, the user will place the neck support apparatus 10 of the present invention in the seat 12 with the seat section 54 of the base 50 in the seating area 30 of the seat 12 and the back support riser 56 against the back wall 18 of the seat 12. If desired, the apparatus 10 can be provided with ties or other devices to secure the apparatus 10 to the seat 12. The user selects the position between the lower end 62 and upper end 64 of back support riser 56 where the support pillow 52 should be placed so neck support members 82 of the support pillow 52 will be around or substantially encircling the neck 47 of the child 14. The support pillow 52 is then attached to the base 50 by threading the strap members 88, which in the embodiment shown engage the support pillow 52 through strap slots 89 in the pillow body 76 as best shown in FIGS. 7 and 11, through the slots 86 in the back support riser 56 such that the back side 80 of the pillow body 76 is in abutting relation with the front side 92 of the back support riser 56, as shown in FIG. 4. With the connecting means 94 connecting the strap members 88, the attachment means 84 will securely hold the support pillow 52 in place on the back support riser 56 of the base 50, as shown in FIGS. 3 and 4. In one embodiment, a single strap member 88 can be threaded through a single slot 86 in the back support riser 56 and then one end of the strap member 88 can be secured to the back side 90 of back support riser 56. In a preferred embodiment, a plurality of strap members 88 are received through a pair of slots 86, which comprise two of a plurality of slot rows 96, to securely attach the support pillow 52 to the base 50. A head support mechanism 98, preferably comprising a head engaging device 100 such as a cap 101 or beanie 104, can be utilized to provide additional support to the child's head 48, and therefore further reduce the likelihood of injury to the child's neck 47. Head engaging device 100 is placed on the child's head 48 and attached to the pillow body 76 of support pillow 52 using a securing means 102, which can comprise one or more pieces of hook-and-loop material or strap members 106 attached to head engaging device 100 that are received through one or more slots 108 in the pillow body 76. When the child 14 is placed in seat 12 and on neck support apparatus 10, apparatus 10 will help maintain the child's head 48 in a generally upright position. This will substantially reduce the likelihood of discomfort or injury to the child 14 that would otherwise result from his or her head 48 swinging side to side or forward while he or she sleeps in the seat 12.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A neck support apparatus to support the neck and head of a child in a seat having a seating area and a back wall extending upwardly therefrom, said neck support apparatus comprising:
a base having a seat section and a back support riser, said seat section sized and configured to be at least substantially received in the seating area of the seat, said back support riser attached to or integral with said seat section and configured so as to extend generally upwardly therefrom, said back support riser sized and configured to be at least substantially received against the back wall of the seat; and
a support pillow having a pillow body with a front side and a back side, said back side of said pillow body attached to said back support riser of said base, said support pillow further comprising one or more neck support members extending outwardly from said front side of said pillow body so as to at least partially enclose the neck of the child when the child is sitting on said neck support apparatus in the seat.

2. The neck support apparatus according to claim 1 further comprising an attachment means interconnecting said support pillow and said base for removably attaching said support pillow to said base.

3. The neck support apparatus according to claim 2, wherein said attachment means comprises one or more slots in said back support riser of said base and one or more strap members associated with said pillow body, each of said strap members configured to be received through at least one of said one or more slots.

4. The neck support apparatus according to claim 3, wherein each of said strap members has a connecting means thereon for connecting said strap members to itself to secure said support pillow to said base.

5. The neck support apparatus according to claim 3, wherein each of said strap members extend to a back side of said back support riser so as to attach said support pillow to a front side of said back support riser.

6. The neck support apparatus according to claim 1 further comprising an arm rest on each of a first side and a second side of said neck support apparatus.

7. The neck support apparatus according to claim 1, wherein said support pillow comprises a pair of said neck support members.

8. The neck support apparatus according to claim 1 further comprising head support means interconnecting the head of the child and the neck support apparatus for supporting the head in a generally upright position.

9. The neck support apparatus according to claim 8, wherein said head support means comprises a head engaging device configured to engage the head of the child and a securing means interconnecting said head engaging device and said support pillow for securing said head engaging device to said support pillow.

10. The neck support apparatus according to claim 8, wherein said head engaging device is one of a cap or a beanie.

11. The neck support apparatus according to claim 1, wherein said support pillow is configured in a character shape with said neck support members being integral with said character shape.

12. A neck support apparatus to support the neck and head of a child in a seat having a seating area and a back wall extending upwardly therefrom, said neck support apparatus comprising:
a base having a seat section and a back support riser, said seat section sized and configured to be at least substantially received in the seating area of the seat, said back support riser attached to or integral with said seat section and configured so as to extend generally upwardly therefrom, said back support riser sized and configured to be at least substantially received against the back wall of the seat;
a support pillow having a pillow body with a front side and a back side, said back side of said pillow body configured to be removably attached to said back support riser of said base, said support pillow further comprising one or more neck support members extending outwardly from said front side of said pillow body so as to at least partially enclose the neck of the child when the child is sitting on said neck support apparatus in the seat; and
an attachment means interconnecting said support pillow and said base for removably attaching said support pillow to said base.

13. The neck support apparatus according to claim 12, wherein said attachment means comprises one or more slots in said back support riser of said base and one or more strap members associated with said pillow body, each of said strap members configured to be received through at least one of said one or more slots.

14. The neck support apparatus according to claim 13, wherein each of said strap members extend to a back side of said back support riser so as to attach said support pillow to a front side of said back support riser.

15. The neck support apparatus according to claim 12 further comprising head support means interconnecting the head of the child and the neck support apparatus for supporting the head in a generally upright position.

16. The neck support apparatus according to claim 15, wherein said head support means comprises a head engaging device configured to engage the head of the child and a securing means interconnecting said head engaging device and said support pillow for securing said head engaging device to said support pillow.

17. The neck support apparatus according to claim 12, wherein said support pillow is configured in a character shape with said neck support members being integral with said character shape.

18. A neck support apparatus to support the neck and head of a child in a seat having a seating area and a back wall extending upwardly therefrom, said neck support apparatus comprising:
a base having a seat section and a back support riser, said seat section sized and configured to be received in the seating area of the seat, said back support riser attached to or integral with said seat section and configured so as to extend generally upwardly therefrom, said back support riser sized and configured to received against the back wall of the seat;
a support pillow having a pillow body with a front side and a back side, said back side of said pillow body configured to be placed in abutting relation with said back support riser of said base, said support pillow further comprising a pair of neck support members extending outwardly from said front side of said pillow body so as to at least partially enclose the neck of the child when the child is sitting on said neck support apparatus in the seat;
one or more slots in said back support riser of said base;
one or more strap members attached to or otherwise associated with said pillow body, each of said strap members configured to be received through at least one of said one or more slots to removably attach said support pillow to said back support riser of said base.

19. The neck support apparatus according to claim 18 further comprising a head engaging device configured to engage the head of the child and a securing means interconnecting said head engaging device and said support pillow for securing said head engaging device to said support pillow so as to support the head of the child in a generally upright position.

20. The neck support apparatus according to claim 18, wherein said support pillow is configured in a character shape with said neck support members being integral with said character shape.
